(19) United States
(12) Patent Application Publication
(10) Pub. No.: US 2019/0349948 A1
(43) Pub. Date: Nov. 14, 2019

(54) A Wireless Device, a Serving Network Node and Respective Method Performed Thereby for Communicating with Each Other

(71) Applicant: Telefonaktiebolaget LM Ericsson (publ), Stockholm (SE)

(72) Inventors: Jonas Fröberg Olsson, Ljungsbro (SE); Martin Hessler, Linköping (SE)

(21) Appl. No.: 16/474,404

(22) PCT Filed: Dec. 8, 2017
(86) PCT No.: PCT/SE2017/051238

§ 371 Date: Jun. 27, 2019

Related U.S. Application Data
(60) Provisional application No. 62/442,508, filed on Jan. 5, 2017.

(51) Int. Cl. H04W 72/08; H04L 5/00; H04L 25/02; H04B 7/06; H04W 24/10; H04W 72/04

(52) U.S. Cl. CPC H04W 72/082; H04L 5/0048; H04L 25/0202; H04B 7/0452; H04B 7/0617; H04W 24/10; H04W 72/046; H04L 5/0057

(57) ABSTRACT

A wireless device, a serving network node and a method performed by a wireless device and a serving network node are provided for communication there between. The wireless device and the serving network node are operable in a wireless communication network supporting beamforming for communication between the wireless device and the serving network node. The method (100) comprises obtaining (110) one or more interference measurements at respective one or more time instances, and receiving (140), from the serving network node, a Channel State Information, CSI, measurement assignment associated with the one or more interference measurements. The method (100) further comprises obtaining (150) a channel estimation based on a CSI-RS transmission; determining (160) a pre-coder based on the obtained channel estimation matching estimated interference according to one or more interference measurements; and transmitting (170) the determined interference matching pre-coder.

### TECHNICAL FIELD

The present disclosure relates to wireless communication and in particular to methods performed by a wireless device and a serving network node operable in a wireless communication network supporting beamforming for communication between the wireless device and the serving network node.

### BACKGROUND

In many wireless communications systems Channel-State Information, CSI, feedback is crucial for obtaining good performance. Reference signals are transmitted by network nodes which are used by wireless devices to estimate the channel state, whereupon the reported CSI feedback typically includes Channel-Quality Indicator, CQI, Rank Indicator, RI, and PMI, Pre-coding Matrix Indicator, values.

The 3^{rd} Generation Partnership Project, 3GPP, Long Term Evolution, LTE, system supports CSI-reporting schemes that rely on the reference symbols being transmitted periodically; the cell-specific reference symbols, CRS, are sent every subframe while the user-specific CSI-RS may be sent with a larger periodicity. Wireless devices such as for example User Equipments, UEs, using transmission mode 10, TM10, rely solely on CSI-RS resources while other UEs typically use the CRS resources at least for interference measurements.

TM10 UEs may be configured to report CSI for multiple CSI-processes, which each may have different CSI-measurement resources. A CSI-measurement resource, CSI-MR, may comprise a CSI-RS (CSI Reference Symbol) resource and a CSI-IM (CSI Interference Measurement) resource. Both the CSI-RS and the CSI-IM resources may be divided into sets of resources, where each set may be identified by CSI-RS configuration index. Each CSI-RS/IM configuration index may indicate resources in every Physical Resource Block, PRB, in the frequency band. A subframe configuration specifies a subframe periodicity and a subframe offset that specify for the UE at which time instances the respective measurement resources are available.

Time filtering/averaging of interference may sometimes be good when the interference variations are un-known to the node serving the UE while it may be bad when the variations may be predicted by the node (serving the UE). To improve performance of coordination features it is from R-13 possible to configure the UE not to time filter/average the interference estimated on the CSI-IM resource. This means that the reported CSI will reflect the momentary quality of the channel at the measurement instance.

In future wireless systems the number of antenna elements especially on the network side are expected to increase dramatically. This means that a transmission from a network node may be beam-formed towards the receiving wireless node of the transmission. When the transmissions to the wireless devices are beam-formed the interference levels experienced by a wireless device will likely be reduced except for more or less seldom peaks in interference levels when interfering beams become directed towards the wireless device. For Massive-MIMO (Multiple Inputs Multiple Outputs), wherein CSI acquisition for the channel part is based on reciprocity (UL reference signals) and not downlink CSI reference signals, it is important to have mechanisms to determine the interference levels experienced by the wireless device.

### SUMMARY

The object is to obviate at least some of the problems outlined above. In particular, it is an object to provide a wireless device, a serving network node and respective methods performed thereby for communicating with each other. These objects and others may be obtained by providing a wireless device, a serving network node and a method performed by a wireless device and a serving network node according to the embodiments attached below.

According to an aspect a method performed by a wireless device for transmission of an interference matching pre-coder is provided. The wireless device is operable in a wireless communication network supporting beamforming for communication between the wireless device and a serving network node. The method comprises obtaining one or more interference measurements at respective one or more time instances, and receiving, from the serving network node, a Channel State Information, CSI, measurement assignment associated with the one or more interference measurements. The method further comprises obtaining a channel estimation based on a CSI-RS transmission; determining a pre-coder based on the obtained channel estimation matching estimated interference according to one or more interference measurements; and transmitting the determined interference matching pre-coder.

According to an aspect a method performed by a serving network node operable in a wireless communication network supporting beamforming for communication between a wireless device and the serving network node is provided. The method comprises receiving a measurement report, from the wireless device, the measurement report indicating one or more interference measurements at respective one or more time instances; providing, to the wireless device, a CSI measurement assignment associated with the one or more interference measurements; and receiving an interference matching pre-coder matching the associated one or more interference measurements.

According to an aspect a wireless device for transmission of an interference matching pre-coder is provided. The wireless device is operable in a wireless communication network supporting beamforming for communication between the wireless device and a serving network node. The wireless device is configured for obtaining one or more interference measurements at respective one or more time instances, and receiving, from the serving network node, a Channel State Information, CSI, measurement assignment associated with the one or more interference measurements. The wireless device is further configured for obtaining a channel estimation based on a CSI-RS transmission; determining a pre-coder based on the obtained channel estimation matching estimated interference according to one or more interference measurements; and transmitting the determined interference matching pre-coder.

According to an aspect a serving network node operable in a wireless communication network supporting beamforming for communication between a wireless device and the serving network node is provided. The serving network node is configured for receiving a measurement report, from the wireless device, the measurement report indicating one or more interference measurements at respective one or more time instances; providing, to the wireless device, a CSI measurement assignment associated with the one or more interference measurements; and receiving an interference matching pre-coder matching the associated one or more interference measurements.

The method performed by the wireless device, the method performed by the serving network node, the wireless device and the network node have several advantages. One possible advantage is that the interference source in a Multiple User, MU,-MIMO scenario with large antenna arrays may be efficiently identified. The solution may both lower overhead in measurement scenarios that could have been handled by legacy solutions and it may enables measurements when legacy methods would not work. Further the measurement reports may be made smaller by only reporting relevant information in relation to the interference. For large antenna arrays the cost of measuring the complete channel (as is done in state of the art solutions) is too high i.e. too many CSI-RS resources are needed or it is needed to use Sounding Reference Signal, SRS, for the reciprocity case which causes high SRS interference. In such scenarios, the proposed solution herein the measurement reports may be made smaller by only reporting relevant information in relation to the interference. Even if the CSI measurement are performed according to the state of the art solutions, there may be multiple beam-forming vectors that are not causing interference that may trigger wrong and/or high overhead reporting and that these beam-forming vectors could hinder identification. In some more rare scenarios these strong beam-forming vectors could also block measuring relevant weaker vectors, either or both due to receiver impairments and the power control on SRS.

### BRIEF DESCRIPTION OF DRAWINGS

Embodiments will now be described in more detail in relation to the accompanying drawings, in which:

FIG. 1a is a flowchart of a method performed by a wireless device operable in a wireless communication network supporting beamforming for communication between the wireless device and a serving network node, according to an exemplifying embodiment.

FIG. 1b is a flowchart of a method performed by a wireless device operable in a wireless communication network supporting beamforming for communication between the wireless device and a serving network node, according to yet an exemplifying embodiment.

FIG. 1c is a flowchart of a method performed by a wireless device operable in a wireless communication network supporting beamforming for communication between the wireless device and a serving network node, according to still an exemplifying embodiment.

FIG. 1d is a flowchart of a method performed by a wireless device operable in a wireless communication network supporting beamforming for communication between the wireless device and a serving network node, according to a further exemplifying embodiment.

FIG. 2a a flowchart of a method performed by a serving network node operable in a wireless communication network supporting beamforming for communication between a wireless device and the serving network node, according to an exemplifying embodiment.

FIG. 2b a flowchart of a method performed by a serving network node operable in a wireless communication network supporting beamforming for communication between a wireless device and the serving network node, according to yet an exemplifying embodiment.

FIG. 2c a flowchart of a method performed by a serving network node operable in a wireless communication network supporting beamforming for communication between a wireless device and the serving network node, according to still an exemplifying embodiment.

FIG. 2d a flowchart of a method performed by a serving network node operable in a wireless communication network supporting beamforming for communication between a wireless device and the serving network node, according to a further exemplifying embodiment.

FIG. 3a is an exemplifying illustration of a scenario in which the solution described herein is applied.

FIG. 3b is an exemplifying and schematic illustration of removal of small effective channels or the selection of similar more effective channels.

FIG. 3c is a flowchart of a method performed by a wireless device operable in a wireless communication network supporting beamforming for communication between the wireless device and a serving network node, according to another further exemplifying embodiment.

FIG. 4 is a block diagram of a wireless device operable in a wireless communication network supporting beamforming for communication between the wireless device and a serving network node, according to an exemplifying embodiment.

FIG. 5 is a block diagram of a wireless device operable in a wireless communication network supporting beamforming for communication between the wireless device and a serving network node, according to another exemplifying embodiment.

FIG. 6 is a block diagram of a serving network node operable in a wireless communication network supporting beamforming for communication between a wireless device and the serving network node, according to an exemplifying embodiment.

FIG. 7 is a block diagram of a serving network node operable in a wireless communication network supporting beamforming for communication between a wireless device and the serving network node, according to another exemplifying embodiment.

FIG. 8 is a block diagram of an arrangement in a wireless device operable in a wireless communication network supporting beamforming for communication between the wireless device and a serving network node, according to an exemplifying embodiment.

FIG. 9 is a block diagram of an arrangement in a serving network node operable in a wireless communication network supporting beamforming for communication between a wireless device and the serving network node, according to an exemplifying embodiment.

### DETAILED DESCRIPTION

Briefly described, a wireless device may be configured to measure interference on a measurement resource wherein the interference measurements (e.g. interference covariance matrix) may be saved to be used for later interference identification. Said saved interference measurements may later be used to compare to measurements on Non-Zero Power, NZP, CSI-RS. The reporting on said CSI-RS may then be limited to the pre-coders causing the interference. Hence sending a large set of pre-coder candidates representing all possible interfering wireless devices may be avoided. The reported pre-coders may thus be used, for example, to avoid scheduling the wireless device with other wireless devices causing high interference.

In some embodiments the measurements may be explicitly associated with a time reference indicating the time when the measurement took place. The wireless device may maintain the interference measurements for later reference. The wireless device may further be configured to receive an indication indicating a time reference where upon reception of the indicator the wireless device may determine a pre-coder for the obtained channel estimation that resembles the interference measurement indicated by the time indication.

The current mechanisms to determine the interference levels experienced by the wireless device are not suitable/optimal for Massive-MIMO for a number of reasons:
Transmission of downlink CSI reference signals are unnecessary to transmit since channel is estimated from Uplink, UL, reference signals; only the interference levels may be needed to be acquired.
Reported CSI is with respect to sampled time-instances both with respect to measurement and reporting. The interference (and channel) between the sample instances will be un-known. Hence, the current CSI reporting is designed with the assumption that true channel and interference at a time instance with a small time-difference from a CSI sample occasion will not be worse than it can be solved by soft-combining. However, with a large degree of beamforming this may change.
HARQ-ACK: A Hybrid Automatic Repeat Request, HARQ, Negative Acknowledgement, NACK, may be interpreted as an indication that the interference level is non-typically high. However, an HARQ-ACK is only present when a transmission has occurred and therefore using HARQ-ACK as an indicator for non-typical interference can only be used “re-actively”.

For some Critical Machine Type Communication, C-MTC, traffic there are tight latency and reliability requirements. The latency requirements may in some scenarios limit the use of HARQ transmissions wherein even the communication to wireless device has to rely in a single transmission that in some extreme scenarios is required to be reached to the wireless device with an error probability as low as 10⁻⁵ or lower. This may be accomplished using a dedicated transmission resource for each such device. For downlink this means that no other network node is allowed to use the dedicated resource for transmissions to other wireless devices. Clearly, such a design will quickly drain the transmission resources as the number of C-MTC devices increases. Another solution may be to not use dedicated resource but use conservative link adaptation to mitigate the uncertainties in interference levels. A problem is that this also consumes a lot of resources, but also that there may be too frequent interference peaks that induce violation to the reliability requirement.

A possible solution may be to configure the wireless device with an Interference Measurement, IM, resource potentially present in all TTIs. The wireless device may perform measurements on the IM resource and classify measured interference according to an obtained interference classification method. The wireless device may then transmit one or more indicators indicating one or more time-references for non-typical interference level measured on said IM resource. This method enables the network to detect that a wireless device at a specific time instance has experienced an un-expectedly high interference. The method also enables the network to take proper coordination action with other network nodes if decided necessary. Further, the non-typical inference report may be extended with spatial information that may give insight of the spatial properties of the non-typical interference. This spatial information may be used to identify which user transmission that is causing the non-typical interference. Such an approach is limited due to that the wireless devices which are experiencing the non-typical interference only can view the pre-coded interference, which is something else than which pre-coder that caused the not-typical interference.

When the wireless device determines a pre-coder for the CSI feedback the pre-coder is determined to maximize the signal quality which means that the pre-coder should suppress the interference as much as possible without decreasing the signal strength. Hence, if two pre-coders give equal signal strength but the first pre-coder match the interference better than the second pre-coder, the wireless device will determine the second pre-coder since it will suppress the interference better.

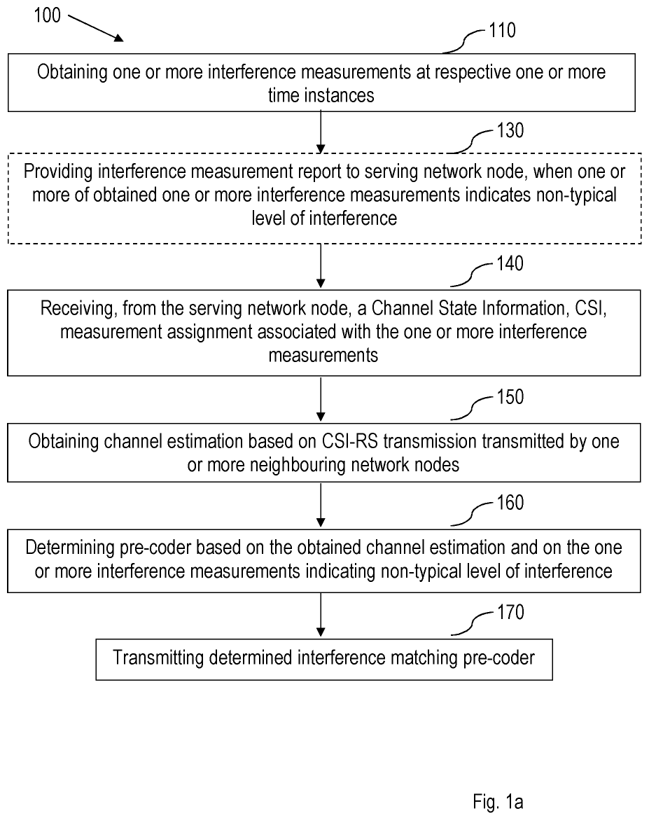

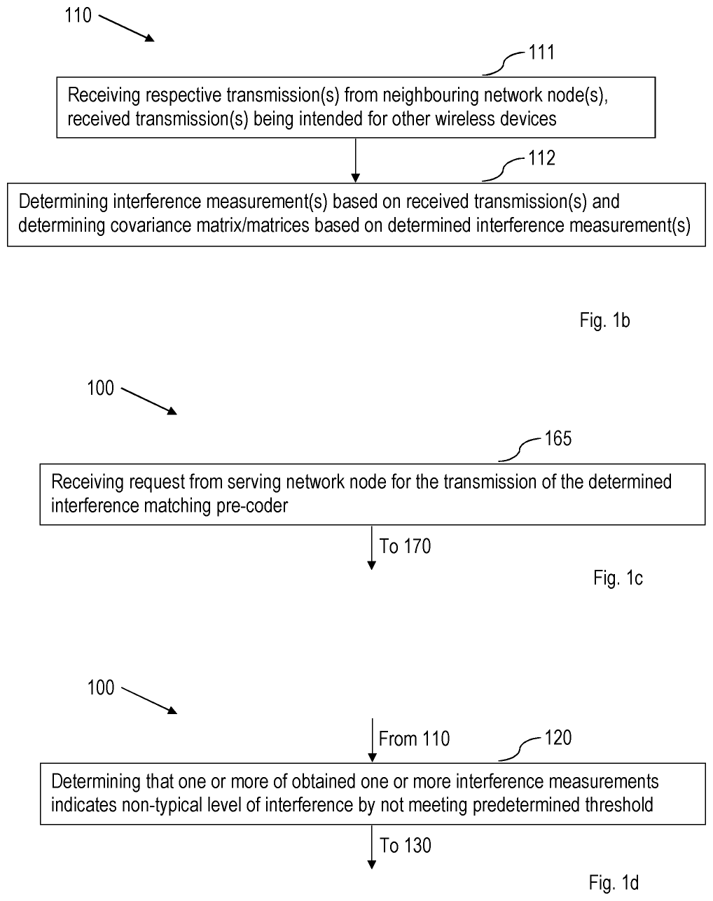

Embodiments herein relate to a method performed by a wireless device for transmission of an interference matching pre-coder. The wireless device is operable in a wireless communication network supporting beamforming for communication between the wireless device and a serving network node. Exemplifying embodiments of such a method performed by a wireless device will now be described with reference to FIGS. 1a to 1d.

FIG. 1a illustrates the method comprising obtaining 110 one or more interference measurements at respective one or more time instances, and receiving 140, from the serving network node, a Channel State Information, CSI, measurement assignment associated with the one or more interference measurements. The method 100 further comprises obtaining 150 a channel estimation based on a CSI-RS transmission; determining 160 a pre-coder based on the obtained channel estimation matching estimated interference according to one or more interference measurements; and transmitting 170 the determined interference matching pre-coder.

The wireless device may receive a plurality of different transmissions, some intended for it and some being overheard as transmissions between other network nodes and wireless devices being in the vicinity so that the wireless device may receive such transmissions. The transmissions that are not intended for the wireless device may cause interference to transmissions that are intended for the wireless device. For example the wireless device may receive a transmission from a neighbouring network node that is intended for another wireless device, referred to as a second wireless device. The transmission may be a data transmission. It is pointed out that the transmission may likewise be transmitted from the second wireless device to the neighbouring network node and still be received (or overheard/intercepted) by the wireless device. Generally, the transmissions are performed using beamforming being associated with a specific pre-coder.

These transmissions may be received with different signal strengths thereby also causing different levels of interference. The wireless device may expect some interference as it is generally difficult to avoid since there generally are a plurality of wireless devices and possibly also network nodes in the vicinity of the wireless device. By the expression “expecting some interference” means that the interference experienced by the wireless device is below a predefined threshold or that the received signal strength of signals is intended for the wireless device is above another predefined threshold. There may be other ways (or parameters to use) to define a level of interference that is expected, thereby also being a typical level of interference.

The wireless device may thus receive at different points in time one or more signals (data or reference) intended for the wireless device and not intended for the wireless device. The wireless device may perform interference measurements on the received signals thereby obtaining 110 one or more interference measurements at respective one or more time instances.

The wireless device may also receive 140 the CSI measurement assignment associated with the one or more interference measurements from the serving network node. The CSI measurement assignment informs the wireless device which CSI-RS the wireless device shall analyse, e.g. by receiving further transmission(s) comprising the CSI-RS of the CSI measurement assignment. This is in order for the wireless device to match the further transmission(s) with interfering matching pre-coder(s).

The wireless device then receives a CSI-RS transmission in corresponding to the CSI-RS of the CSI measurement assignment and estimates the channel based on the received CSI-RS transmission, thereby obtaining 150 the channel estimation based on the CSI-RS transmission.

The wireless device may then determine 160 the pre-coder based on the obtained channel estimation matching estimated interference according to one or more interference measurements. The wireless device may have stored the previously obtained 110 one or more interference measurements, e.g. by means of storing corresponding interference covariance matrices. The pre-coder is determined or selected to match the interference, irrespective of whether the determined/selected pre-coder may give the best signal quality. In other words, the pre-coder is not determined/selected to supress the interference but rather to resemble the interference as much as possible.

The wireless device may then transmit 170 the determined interference matching pre-coder. The determined interference matching pre-coder may be sent to the serving network node or to a neighbouring network node.

The method performed by the wireless device has several advantages. One possible advantage is that the interference source in a Multiple User, MU,-MIMO scenario with large antenna arrays may be efficiently identified. The solution may both lower overhead in measurement scenarios that could have been handled by legacy solutions and it may enables measurements when legacy methods would not work. Further the measurement reports may be made smaller by only reporting relevant information in relation to the interference. For large antenna arrays the cost of measuring the complete channel (as is done in state of the art solutions) is too high i.e. too many CSI-RS resources are needed or it is needed to use Sounding Reference Signal, SRS, for the reciprocity case which causes high SRS interference. In such scenarios, the proposed solution herein the measurement reports may be made smaller by only reporting relevant information in relation to the interference. Even if the CSI measurement are performed according to the state of the art solutions, there may be multiple beam-forming vectors that are not causing interference that may trigger wrong and/or high overhead reporting and that these beam-forming vectors could hinder identification. In some more rare scenarios these strong beam-forming vectors could also block measuring relevant weaker vectors, either or both due to receiver impairments and the power control on SRS.

The method 100 may further comprise, as illustrated in FIG. 1a by the optional dotted box 130, providing an interference measurement report to the serving network node when one or more of the obtained one or more interference measurement indicates a non-typical level of interference.

By providing the interference measurement report to the serving network node, the network node is enabled to take appropriate actions as will be described in more detail below. Merely as an example, the serving network node may communicate with one or more neighbouring network nodes potentially directly causing the interference by transmission(s) to its/their wireless devices and/or potentially indirectly causing the interference by transmission(s) from its/their wireless devices.

By providing the interference measurement report to the serving network node, the network node is enabled to determine the CSI measurement assignment to be sent to the wireless device.

The non-typical level of interference may be defined or determined in different ways. Analogously to the expression “the wireless device expecting some interference” meaning that the interference experienced by the wireless device is below a predefined threshold or that the received signal strength of signals is intended for the wireless device is above another predefined threshold; the non-typical level of interference may be defined or determined for example by the level of interference being above a predefined threshold, the received signal strength of signals is intended for the wireless device is below another predefined threshold. There may be other ways (or parameters to use) to define a level of interference that is expected, thereby also being a non-typical level of interference.

The received CSI measurement assignment may be associated with the one or more measurements indicating the non-typical level of interference.

The wireless device may report the obtained one or more interference measurements at respective one or more time instances regardless of the level of interference, or the wireless device may e.g. only report the obtained one or more interference measurements at respective one or more time instances that indicates the non-typical level of interference.

Since expected, or typical, level of interference is acceptable and won't degrade signal or channel quality too seriously, the serving network node may focus on the transmission(s) causing the non-typical level of interference.

Consequently, the CSI measurement assignment may be associated with the one or more measurements indicating the non-typical level of interference in order to find, determine, or select an interference matching pre-coder for the transmission(s) causing the non-typical level of interference at the wireless device.

The method 100 may further comprise, wherein the transmitting 170 of the determined interference matching pre-coder comprises transmitting an associated quality value and optionally also the obtained channel estimation.

In order for the serving network node and/or any of the neighbouring network node(s) to know how well the interference matching pre-coder actually matches the interference, the transmitting 170 of the determined interference matching pre-coder may comprise transmitting the associated quality value. The quality value may be e.g. example be a decimal value between 0 and 1, or an integer between 1-5 or 0-10 etc. indicating how well the interference matching pre-coder actually matches the interference. For example, a low quality value may indicate that the interference matching pre-coder does not match the interference very well, whereas a high quality value may indicate that the interference matching pre-coder matches the interference very well.

The wireless device may also enclose the obtained channel estimation, e.g. by means of a CQI value, when transmitting 170 the determined interference matching pre-coder. The obtained channel estimation may be used by the serving network node or neighbouring network nodes for estimating from the quality value how strong the interference will be if the interference matching pre-coder is used. I.e., how important it is to avoid using it. Avoid using the pre-coder may be associated with a cost for other wireless devices which has to judged compared to the gain that said wireless device will see.

The obtained channel estimation may be represented by a quality value, for example a Channel Quality Indicator, CQI, value.

There are different ways to represent the obtained channel estimation. In an example, the CQI is used. The CQI is an indicator carrying the information on how good/bad the communication channel quality is.

The CQI may indicate a suitable downlink transmission data rate, i.e. a Modulation and Coding Scheme, MCS, value. CQI is a 4-bit integer and is based on the observed signal-to-interference-plus-noise ratio, SINR, at the wireless device.

The method 100 may further comprise, as illustrated in FIG. 1c, receiving 165 a request from the serving network node for the transmission of the determined interference matching pre-coder.

The wireless device may be triggered to transmit the determined interference matching pre-coder. The request from the serving network node for the transmission of the determined interference matching pre-coder may cause the wireless device to initially send the obtained one or more interference measurements at respective one or more time instances.

However, in other examples, the wireless device may perform those actions irrespective of the reception of the request from the serving network node for the transmission of the determined interference matching pre-coder. The request may be received by the wireless device after having received the CSI measurement assignment associated with the one or more interference measurements.

In yet other examples, the request for the transmission of the determined interference matching pre-coder may be comprised in the CSI measurement assignment associated with the one or more interference measurements.

The obtaining 110 of the one or more interference measurements at respective one or more time instances may comprise, as illustrated in FIG. 1b, receiving 111 respective transmission(s) from neighbouring network node(s), the received transmission(s) being intended for other wireless devices; and determining 112 interference measurement(s) based on the received transmission(s) and determining covariance matrix/matrices based on the determined interference measurement(s).

The wireless device may receive various transmissions from its serving network nodes, from other wireless devices in its vicinity and also from neighbouring network nodes as described above.

The wireless device may use these received transmissions to determine interference measurement(s) and corresponding covariance matrix/matrices based on the determined interference measurement(s).

In an example, the one or more interference measurements comprise performing measurements on one or more CSI interference measurement resources.

A CSI measurement resource may comprise a CSI-RS resource and a CSI-IM resource. Both the CSI-RS and the CSI-IM resources may be divided into sets of resources, where each set may be identified by CSI-RS configuration index. Each CSI-RS/IM configuration index may indicate resources in every Physical Resource Block, PRB, in the frequency band.

The wireless device may thus perform measurements on one or more CSI-IM resources in order to determine the level of interference. As explained above, the level of interference may be a typical level or a non-typical level of interference.

In another example, the one or more interference measurements comprises performing measurements on one or more CSI reference signal measurement resources (also referred to as CSI-RS resources), and estimating interference based on a channel estimate of a CSI reference signal.

A CSI reference signal measurement resource is also referred to as a CSI-RS resource.

The wireless device receiving the transmission may measure received signal strength and thus determine the channel quality and/or the interference experienced by the wireless device. The mentioned resources are examples and do not exclude other resource(s) to determine the one or more interference measurements. It is also possible to use DMRS (De-Modulation Reference Signal) resource or resources for other reference signals as well as resources for control and data messages.

The method may further comprise, as illustrated in FIG. 1d, determining 120 that one or more of the obtained one or more interference measurements indicates the non-typical level of interference by not meeting a predetermined threshold.

At least one of the obtained one or more interference measurements indicates the non-typical level of interference, e.g. by not meeting the predetermined threshold.

As explained above, the wireless device may expect at least a typical level of interference, which may not be necessary to take any major actions against. However, if the wireless device detects that it experiences a non-typical level of interference, actions may be taken to mitigate or overcome the consequences thereof. Consequently, the wireless device may determine 120 that one or more of the obtained one or more interference measurements indicate the non-typical level of interference. Thus may cause the wireless device to provide the interference measurement report to the serving network node.

The interference measurement report provided to the serving network node may comprise information about the time instance(s) associated with the one or more interference measurements indicating the non-typical level of interference.

Different transmissions being performed by neighbouring network nodes or other wireless device not intended for the wireless device but still received by the wireless device are received at one or more points in time.

The wireless device may inform the serving network node about the points in time such transmissions were received by the wireless device. This may enable or facilitate the serving network node coordinating with neighbouring network nodes in order to mitigate and/or overcome non-typical level of interference suffered by the wireless device.

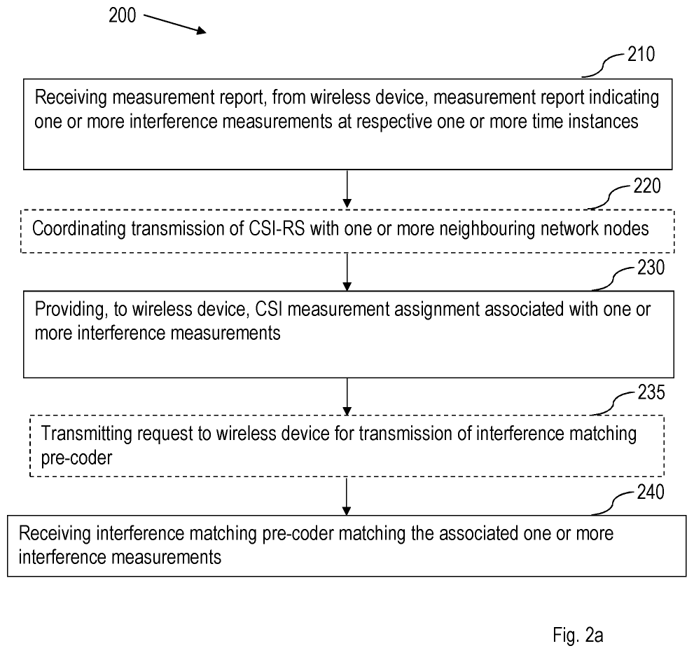

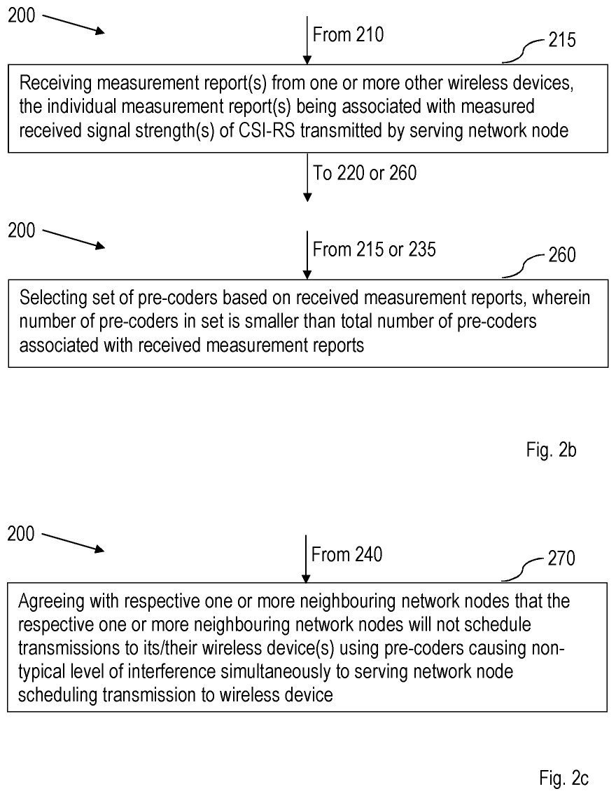

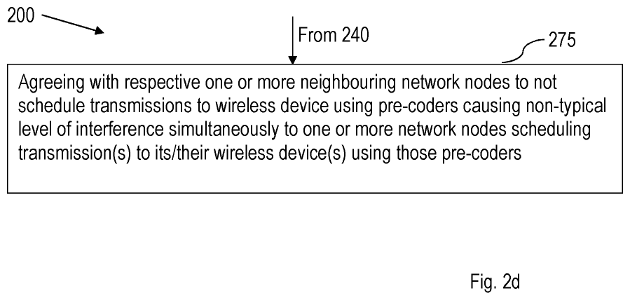

Embodiments herein also relate to a method performed by a serving network node operable in a wireless communication network supporting beamforming for communication between a wireless device and the serving network node. Exemplifying embodiments of such method performed by a serving network node will now be described with reference to FIGS. 2a to 2d.

FIG. 2a illustrates the method comprising receiving 210 a measurement report, from the wireless device, the measurement report indicating one or more interference measurements at respective one or more time instances; providing 230, to the wireless device, a CSI measurement assignment associated with the one or more interference measurements; and receiving 240 an interference matching pre-coder matching the associated one or more interference measurements.

The serving network node may receive 210 the measurement report, from the wireless device, the measurement report indicating one or more interference measurements at respective one or more time instances. As describe above, the wireless device may receive transmissions from the network node as well as from other wireless device and neighbouring network nodes causing interference at the wireless device. This is reported to the serving network node.

The serving network node is in charge of transmissions to and from the wireless device and is the entity that may take actions in order to overcome or mitigates the experienced interference at the wireless device. Consequently, the wireless device provides, e.g. transmits, the measurement report to the serving network node.

The network node then providing 230 the CSI measurement assignment associated with the one or more interference measurements to the wireless device. The way that the serving network node determines the CSI measurement assignment will be described in more detail below. The CSI measurement assignment informs the wireless device which CSI-RS the wireless device shall analyse, e.g. by receiving further transmission(s) comprising the CSI-RS of the CSI measurement assignment. This is in order for the wireless device to match the further transmission(s) with interfering matching pre-coder(s).

As described above, the wireless device determines the interference matching pre-coder and transmits the determined interference matching pre-coder so that it may be received 240 by the serving network node.

The method performed by the serving network node has the same advantages as the method performed by the wireless device. One possible advantage is that the interference source in a Multiple User, MU,-MIMO scenario with large antenna arrays may be efficiently identified. The solution may both lower overhead in measurement scenarios that could have been handled by legacy solutions and it may enables measurements when legacy methods would not work. Further the measurement reports may be made smaller by only reporting relevant information in relation to the interference. For large antenna arrays the cost of measuring the complete channel (as is done in state of the art solutions) is too high i.e. too many CSI-RS resources are needed or it is needed to use Sounding Reference Signal, SRS, for the reciprocity case which causes high SRS interference in the serving node. In such scenarios, the proposed solution herein the measurement reports may be made smaller by only reporting relevant information in relation to the interference. Even if the CSI measurement are performed according to the state of the art solutions, there may be multiple beam-forming vectors that are not causing interference that may trigger wrong and/or high overhead reporting and that these beam-forming vectors could hinder identification. In some more rare scenarios these strong beam-forming vectors could also block measuring relevant weaker vectors, either or both due to receiver impairments and the power control on SRS.

One or more measurement report may indicate that a non-typical level of interference was detected by the wireless device.

It may happen that, as described above, that the level of interference is non-typical, meaning that the interference is relatively strong and that actions may be taken in order to mitigate or overcome the experienced interference at the wireless device.

The method 200 may further comprise, as illustrated in FIG. 2a by the dotted line, coordinating 220 transmission of CSI-RS with one or more neighbouring network nodes.

Generally, the serving network node may communicate directly, or indirectly via an intermediate node, with one or more neighbouring network nodes. The coordination may e.g. comprise determining that a neighbouring network node performed a MU-MIMO transmission to multiple wireless devices, wherein e.g. one or more pre-coders for respective wireless devices included in the MU-MIMO transmission caused the non-typical level of interference.

The serving network node may, e.g. based on the coordination with one or more neighbouring network nodes determine the CSI measurement assignment.

The CSI measurement assignment may be associated with the one or more interference measurements indicating the non-typical level of interference.

On order for the serving network node to mitigate or overcome the interference experienced by the wireless device, the network node determines the CSI measurement assignment, wherein the CSI measurement assignment may be associated with the one or more interference measurements indicating the non-typical level of interference.

As described above, the wireless device receiving the CSI measurement assignment may perform one or more measurements on e.g. CSI-RS in accordance to the CSI measurement assignment in order to determine the interference matching pre-coder

In an example as explained above, the non-typical level of interference corresponds to the level of interference not meeting a predetermined threshold.

The coordinating 220 of transmission of CSI-RS, with one of more neighbouring network nodes may comprise determining which pre-coders where used in the transmission(s) at the respective time instance(s) that caused the non-typical level of interference was at the wireless device.

Different transmissions directed to, or intended for, different wireless devices. Individual wireless devices may be assigned different pre-coders, which may be correlated e.g. to the beamforming for individual wireless devices.

The serving network node has received the interference measurements from the wireless device, which may comprise time instances when non-typical level of interference was detected. The serving network node may then communicate with one or more network nodes in order to determine which transmission(s) the one or more network nodes performed (or received) at those time instances when non-typical level of interference was detected by the wireless device. In this manner, the serving network node may determine which pre-coders where used in the transmission(s) at the respective time instance(s) that caused the non-typical level of interference was at the wireless device.

Consequently, by determining which pre-coders where used in the transmission(s) at the respective time instance(s) that caused the non-typical level of interference was at the wireless device, the serving network node may assign the determined interference matching pre-coder to the wireless device and/or schedule transmissions to/from the wireless device such that non-typical level of interference is avoided.

The method 200 may further comprise, as illustrated in FIG. 2b, receiving 215 measurement report(s) from one or more other wireless devices, the individual measurement report(s) being associated with measured received signal strength(s) of CSI-RS transmitted by the serving network node, and selecting 260 a set of pre-coders based on the received measurement reports, wherein the number of pre-coders in the set is smaller than the total number of pre-coders associated with the received measurement reports.

By using several received measurement report(s), the serving network node may determine where in a spatial dimension different wireless devices are positioned. The received signal strength(s) of CSI-RS transmitted by the serving network node also indicates to the serving network node which pre-coders provide good interference matching and/or which may be used for transmissions from/to the serving network node. A pre-coder may be associated with a beamforming for a transmission between the serving network node and a wireless device. The serving network node may then select the set of pre-coders, wherein the serving network node may group wireless devices together, wherein one pre-coder is assigned per group of wireless devices. The network node may thus exclude some pre-coders, wherein the number of pre-coders in the set is smaller than the total number of pre-coders associated with the received measurement reports.

The selecting 260 of the set of pre-coders may comprise removing the pre-coders associated with the weakest eigenvalues in a Singular Value Decomposition, SVD, for the wireless devices.

Different pre-coders may be associated with individual eigenvalues. Eigenvalues are a special set of scalars associated with a linear system of equations. The SVD is a factorisation of a real or complex matrix.

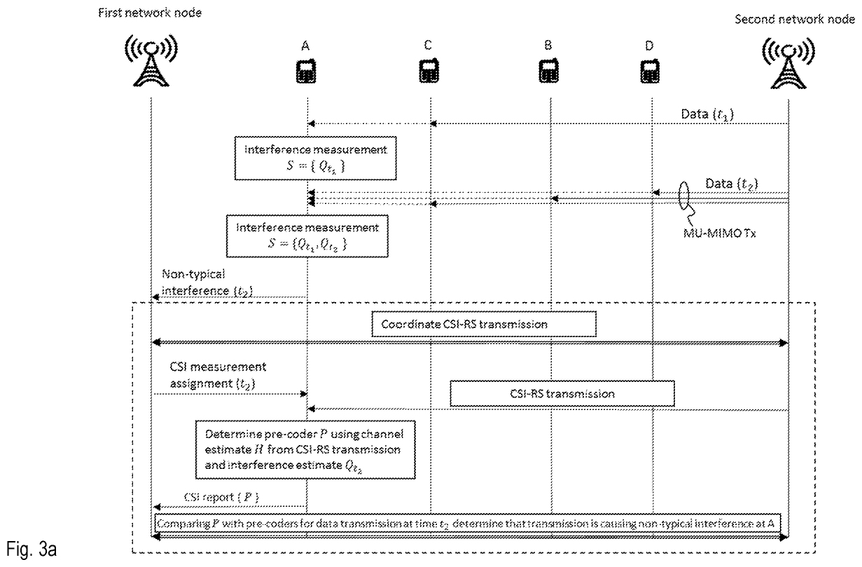

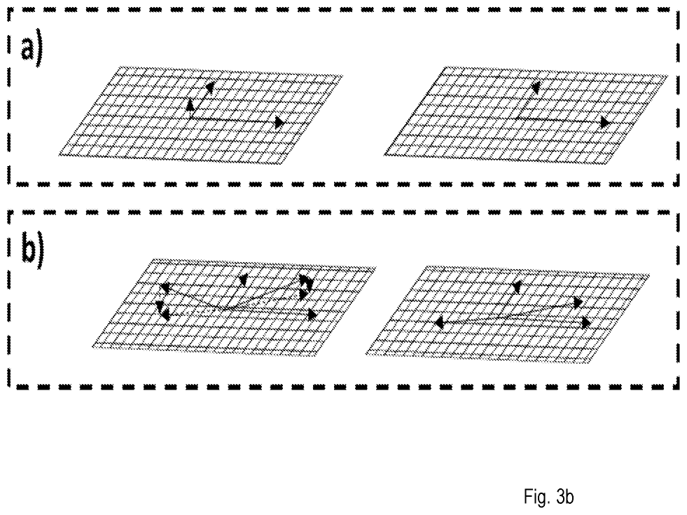

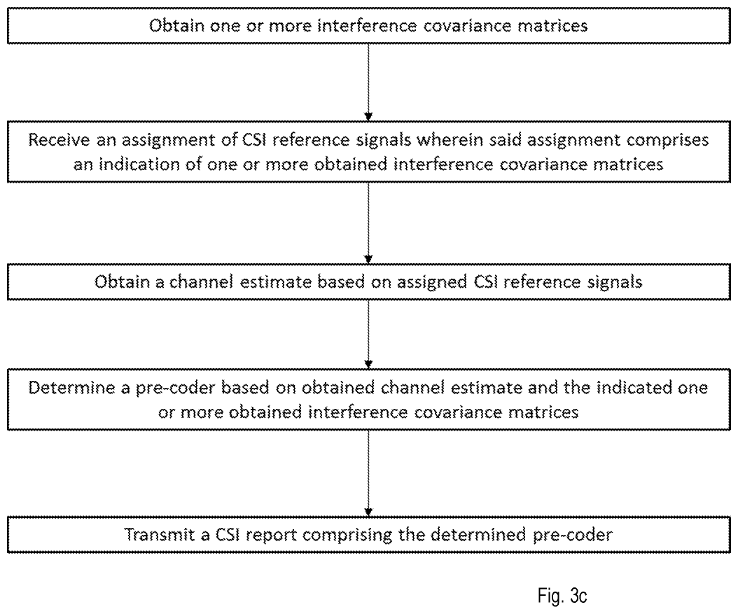

That is, looking e.g. at FIG. 3b, pre-coders associated with the weakest eigenvalues in the SVD for the wireless devices are removed and only the strongest are kept.

In an example, the method further comprises, as illustrated in FIG. 2c, agreeing 270 with respective one or more neighbouring network nodes that the respective one or more neighbouring network nodes will not schedule transmissions to its/their wireless device(s) using pre-coders causing the non-typical level of interference simultaneously to the serving network node scheduling transmission to the wireless device.

In order to reduce the interference experienced by the wireless device, the serving network node and the one or more neighbouring network nodes may agree on not schedule transmissions to their respective wireless device(s) using pre-coders causing the non-typical level of interference simultaneously.

In one example, the one or more neighbouring network nodes refrain from scheduling transmissions to its/their wireless device(s) using pre-coders causing the non-typical level of interference simultaneously to the serving network node scheduling transmission to the wireless device. In other words, they yield for the serving network node.

In another example, as illustrated in FIG. 2d, the method further comprises agreeing 275 with respective one or more neighbouring network nodes to not schedule transmissions to the wireless device using pre-coders causing the non-typical level of interference simultaneously to the one or more network nodes scheduling transmission(s) to its/their wireless device(s) using those pre-coders.

This is another option for the serving network node to reduce the interference is to yield for the one or more neighbouring network nodes. In other words, the serving network node refrains from scheduling transmissions to the wireless device using pre-coders causing the non-typical level of interference simultaneously to the one or more network nodes scheduling transmission(s) to its/their wireless device(s) using those pre-coders.

The method 200 may further comprise transmitting 235 a request to the wireless device for the transmission of the interference matching pre-coder.

It may be that the serving network node wants to request the wireless device to transmit the interference matching pre-coder. The serving network node may have several reasons for wanting to request the interference matching pre-coder. Merely as an example, the serving network node may receive one or more retransmission requests from a wireless device thereby suspecting that the wireless device is suffering from an unfortunate interference situation.

The requesting of interference matching pre-coder may in some embodiments be required; otherwise the wireless device will not transmit the pre-coder. In other embodiments the wireless device is configured to send the pre-coder periodically without needing to receive a request.

If there is rarely a need to receive the interference matching pre-coder a periodic reporting may be un-necessary and waste of uplink resources. Hence, an a-periodic report where the pre-coder is only sent upon request may be preferable in such a scenario.

It may also be that the serving network node has detected a new semi-stationary wireless device of some sort, which may be affecting the interference situation.

FIG. 3a is an exemplifying illustration of a scenario in which the solution described herein is applied.

In this illustrative and non-limiting example a scenario is considered where a first wireless device A is served be a first network node and three other wireless devices B, C and D are present in the vicinity of A. The wireless device A is utilising the solution described above where it is configured to perform interference measurements on an interference measurement resource and maintain a time reference to the measured interference as illustrated in FIG. 3a as maintaining a list S of interference covariance matrices and associated time reference. The wireless device performs two interference measurements in time instances t₁ and t₂ where the interference at time t₂ is determined non-typically (high). The wireless device A therefore transmits a non-typical interference report indicating the time reference t₂ which is received by first network node. The first network node coordinates with the second network node wherein it is determined that the second network node performed a MU-MIMO transmission to the wireless devices B, C and D. The network nodes may deduce that either the transmission to B or transmission to D, or both, caused the non-typical level of interference. The transmission to C may be excluded since at time t₁ wireless device did not indicate non-typical interference. To determine which of the transmissions caused the interference the first network node may assign first wireless device to determine a pre-coder that used on the channel H estimated from the transmitted CSI-RS that resembles the interference Qₜ_{₂}. In some embodiments the wireless device determines a pre-coder P that minimises:

∥HPP*H*−Qₜ_{_{2∥}}

In other embodiments the term comprising H is scaled to reflect a power difference. In some such embodiments, the scaling factor may be comprised in the assignment assigning the CSI-RS transmission for estimation of H. In further other embodiments the minimisation may be with respect to interference after equalisation. For example, if an equalisation matrix Wₜ_{₂}was determined when the interference covariance matrix Qₜ_{₂} was measured, then the wireless device may determine a pre-coder P that minimises:

∥Wₜ_{₂}HPP*H*W*ₜ_{₂}−Wₜ_{₂}Qₜ_{₂}W*ₜ_{₂}∥.

The determined pre-coder P may be transmitted to first network node that may coordinate with second network node wherein the pre-coder P may be compared against the pre-coders used for the transmission performed at time t₁.

In some embodiment the pre-coder P may be rank-restricted to a rank n, in some embodiments pre-coder P has always rank 1, in some embodiments the wireless device may only pick rank n+1 if the above expression is sufficiently much smaller for rank n+1 compared to rank n, for example, 1 dB smaller.

When the pre-coder P has been compared to the transmissions at time t₁, the network (e.g. the neighbouring network node) may react either by not scheduling the corresponding users together with UE A. It may also react by rank restricting the corresponding users by removing the columns in the pre-coders that is causing the high interference. In some other embodiments a new pre-coder may be derived by nulling in the beam-direction(s) represented by pre-coder P as reported by UE A.

One of the gains with, or advantages of, the solution described herein is to lower overhead from CSI-RS measurements. Here it is described some options how to harvest the gain. Gains are possible both in the overhead from CSI-RS on the radio interface and/or in the signalling of CSI to determine the cause of interference.

In some embodiments, the overhead saving may be that CSI-report needs only to contain pre-coder P matching the interference Q, while without the solution, a possible alternative solution would be to send sufficient channel information to the base-station to make it possible to estimate the impact of each of the interfering users. But for large antenna arrays this may potentially be much more data than the data relating to the subset of transmissions causing interference and thus contained in the covariance matrix Q.

In an example, it only needed to trigger an explicit interference estimation when a high interference situation has occurred. If the wireless device uses the solution described herein, here where Q is kept for the high interference occasion, then the explicit interference estimation may be done on the NZP CSI-RS transmissions from interfering network node(s). For example, reverting to FIG. 3a, using the resource where UEs B, C, D are configured to determine CSI. The coordination step for enabling accurate CSI measurement to second network node may be to assigning CSI measurements to UE A only when needed. Hence, UE A is only assigned to send a CSI report when doing the measurement and also only blanking (if needed), of first base station (i.e. network node) may be applied at these occasions.

In some embodiments, the CSI-RS measurement resource to a second base station (network node) for which interference coordination is enabled is a smaller set of pre-coded NZP-CSI-RS than the joint set representing the transmissions to the UEs B, C, D.

In some embodiments, this set may be done by pruning unnecessary elements, i.e. that second network node may mute without affecting the throughput to UEs B, C, D significantly e.g. removing the weakest eigenvalues in the SVD for said UEs, schematically depicted in FIG. 3b top part (a). In some embodiments, as smaller set of beam-forming vectors is chosen so that projection of the effective channel of all used beam-forming vectors used by UEs B, C, D may be represented with low loss i.e. that the norm of the projected effective channel vectors is above a threshold e.g. 0.9, schematically depicted in FIG. 3b bottom part (b). In some of the described embodiments, it may happen that when UE A measures on the smaller set it does not see a match to Q, hence the removal phase has removed the cause of the interference. In that case just restricting the transmissions to B, C, D for a duration to this smaller set may be used to avoid the cause of the interference.

In some situations, the second network node is not unique, that is, there is at least two candidates of network nodes that may cause the interference. In that case the system may perform the solution described herein simultaneously to a multiple of network nodes, i.e. parallel probing. The parallel probing may be done either by reporting a joint pre-coder P or by reporting to pre-coders P and P′ and sending the relevant precoding information to the two or more network nodes. In some embodiment the system (the network nodes) may randomly or using historic data guess the likely network node and execute the solution described herein for that second node, and if that node is not guilty continue with a different network node. That is, do a sequential probing.

FIG. 3c is a flowchart of a method performed by a wireless device operable in a wireless communication network supporting beamforming for communication between the wireless device and a serving network node, according to another further exemplifying embodiment. FIG. 3c illustrates the method comprising the wireless device obtaining one or more interference covariance matrices and receiving an assignment of CSI reference signals, wherein said assignment comprises an indication of one or more obtained interference covariance matrices.

The method comprises the wireless device also obtaining a channel estimate based on the assigned CSI reference signals. The wireless device further determines a pre-coder based on the obtained channel estimate and the indicated one or more obtained interference covariance matrices according to this exemplifying embodiment of the method. Further, the wireless device transmits a CSI report comprising the determined pre-coder.

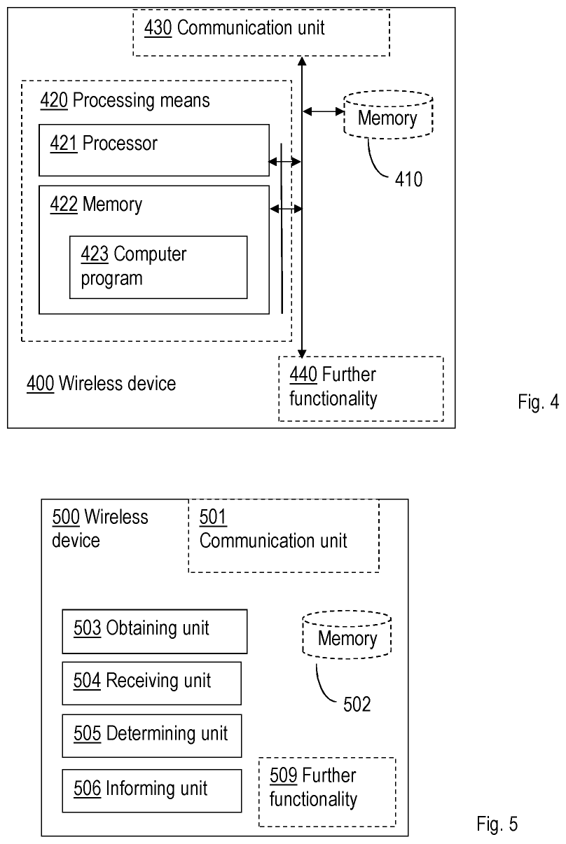

Embodiments herein also relate to a wireless device for communication between the wireless device and a serving network node. Exemplifying embodiments of such a wireless device will now be described with reference to FIGS. 4 and 5. The wireless device is operable in a wireless communication network supporting beamforming for communication between the wireless device and a serving network node.

FIGS. 4 and 5 illustrate the wireless device 400, 500 being configured for obtaining one or more interference measurements at respective one or more time instances; and receiving, from the serving network node, a Channel State Information, CSI, measurement assignment associated with the one or more interference measurements. The wireless device 400, 500 is also configured for obtaining a channel estimation based on a CSI-RS transmission; determining a pre-coder based on the obtained channel estimation matching estimated interference according to one or more interference measurements; and informing the serving network node about the determined interference matching pre-coder.

The wireless device 400, 500 may be implemented or realised in different ways. An exemplifying implementation is illustrated in FIG. 4. FIG. 4 illustrates the wireless device 400 comprising a processor 421 and memory 422, the memory comprising instructions, e.g. by means of a computer program 423, which when executed by the processor 421 causes the wireless device 400 to obtain one or more interference measurements at respective one or more time instances; and to receive, from the serving network node, a Channel State Information, CSI, measurement assignment associated with the one or more interference measurements. The memory further comprises instructions, e.g. by means of a computer program 423, which when executed by the processor 421 causes the wireless device 400 to obtain a channel estimation based on a CSI-RS transmission; to determine a pre-coder based on the obtained channel estimation matching estimated interference according to one or more interference measurements; and to inform the serving network node about the determined interference matching pre-coder.

FIG. 4 also illustrates the wireless device 400 comprising a memory 410. It shall be pointed out that FIG. 4 is merely an exemplifying illustration and memory 410 may optionally, be a part of the memory 422 or be a further memory of the wireless device 400 operable in a communication network. The memory may for example comprise information relating to the wireless device 400, to statistics of operation of the wireless device 400, just to give a couple of illustrating examples. FIG. 4 further illustrates the wireless device 400 comprising processing means 420, which comprises the memory 422 and the processor 421. Still further, FIG. 4 illustrates the wireless device 400 comprising a communication unit 430. The communication unit 430 may comprise an interface through which the wireless device 400 communicates with other nodes, servers, wireless devices or entities of the communication network. FIG. 4 also illustrates the wireless device 400 comprising further functionality 440. The further functionality 440 may comprise hardware of software necessary for the wireless device 400 to perform different tasks that are not disclosed herein.

An alternative exemplifying implementation of the wireless device 400, 500 is illustrated in FIG. 5. FIG. 5 illustrates the wireless device 500 comprising an obtaining unit 503 for obtaining one or more interference measurements at respective one or more time instances; and a receiving unit 504 for receiving, from the serving network node, a Channel State Information, CSI, measurement assignment associated with the one or more interference measurements. By means of the obtaining unit 503, the wireless device 500 is also configured for obtaining a channel estimation based on a CSI-RS transmission. FIG. 5 also illustrates the wireless device 500 comprising a determining unit 505 for determining a pre-coder based on the obtained channel estimation matching estimated interference according to one or more interference measurements; and an informing unit 506 for informing the serving network node about the determined interference matching pre-coder. The informing unit may also be referred to as a transmitting unit.

In FIG. 5, the wireless device 500 is also illustrated comprising a communication unit 501. Through this unit, the wireless device 500 is adapted to communicate with other nodes and/or entities in the communication network. The communication unit 501 may comprise more than one receiving arrangement. For example, the communication unit may be connected to both a wire and an antenna, by means of which the wireless device 500 is enabled to communicate with other nodes and/or entities in the communication network. Similarly, the communication unit 501 may comprise more than one transmitting arrangement, which in turn is connected to both a wire and an antenna, by means of which the wireless device 500 s enabled to communicate with other nodes and/or entities in the communication network. The wireless device 500 further comprises a memory 502 for storing data. Further, the wireless device 500 may comprise a control or processing unit (not shown) which in turn is connected to the different units 503-505. It shall be pointed out that this is merely an illustrative example and the wireless device 500 may comprise more, less or other units or modules which execute the functions of the wireless device 500 in the same manner as the units illustrated in FIG. 5.

It should be noted that FIG. 5 merely illustrates various functional units in the wireless device 500 in a logical sense. The functions in practice may be implemented using any suitable software and hardware means/circuits etc. Thus, the embodiments are generally not limited to the shown structures of the wireless device 500 and the functional units. Hence, the previously described exemplary embodiments may be realised in many ways. For example, one embodiment includes a computer-readable medium having instructions stored thereon that are executable by the control or processing unit for executing the method steps in the wireless device 500. The instructions executable by the computing system and stored on the computer-readable medium perform the method steps of the wireless device 500 as described in the different embodiments herein.

The wireless device has the same possible advantages as the method performed by the wireless device, i.e. the advantages mentioned in relation to the method performed by the wireless device are also applicable to the wireless device itself. One possible advantage is that the interference source in a Multiple User, MU,-MIMO scenario with large antenna arrays may be efficiently identified. The solution may both lower overhead in measurement scenarios that could have been handled by legacy solutions and it may enables measurements when legacy methods would not work. Further the measurement reports may be made smaller by only reporting relevant information in relation to the interference. For large antenna arrays the cost of measuring the complete channel (as is done in state of the art solutions) is too high i.e. too many CSI-RS resources are needed or it is needed to use Sounding Reference Signal, SRS, for the reciprocity case which causes high SRS interference. In such scenarios, the proposed solution herein the measurement reports may be made smaller by only reporting relevant information in relation to the interference. Even if the CSI measurement are performed according to the state of the art solutions, there may be multiple beam-forming vectors that are not causing interference that may trigger wrong and/or high overhead reporting and that these beam-forming vectors could hinder identification. In some more rare scenarios these strong beam-forming vectors could also block measuring relevant weaker vectors, either or both due to receiver impairments and the power control on SRS.

The wireless device 400, 500 may further be configured for providing an interference measurement report to the serving network node when one or more of the obtained one or more interference measurement indicates a non-typical level of interference.

The received CSI measurement assignment may associated with the one or more measurements indicating the non-typical level of interference.

The wireless device 400, 500 may further be configured for transmitting the determined interference matching pre-coder by transmitting an associated quality value and optionally also the obtained channel estimation.

The obtained channel estimation may be represented by a quality value, for example a Channel Quality Indicator, CQI, value.

The wireless device 400, 500 may further be configured for receiving a request from the serving network node for the transmission of the determined interference matching pre-coder.

The wireless device 400, 500 may be configured for obtaining the one or more interference measurements at respective one or more time instances by receiving respective transmission(s) from neighbouring network node(s) and/or wireless devices, and determining interference measurement(s) based on the received transmission(s) and determining covariance matrix/matrices based on the determined interference measurement(s).

The one or more interference measurements may comprise performing measurements on one or more CSI interference measurement resources.

The one or more interference measurements may comprise performing measurements on (a) one or more CSI reference signal measurement resources, and estimating interference based on a channel estimate of a CSI reference signal, and/or (b) one or more Demodulation Reference Signals, DMRS, measurement resources, and estimating interference based on a channel estimate of a DMRS.

The wireless device 400, 500 may still further being configured for determining that one or more of the obtained one or more interference measurements indicates the non-typical level of interference by not meeting a predetermined threshold.

The interference measurement report provided to the serving network node may comprise information about the time instance(s) associated with the one or more interference measurements indicating the non-typical level of interference.

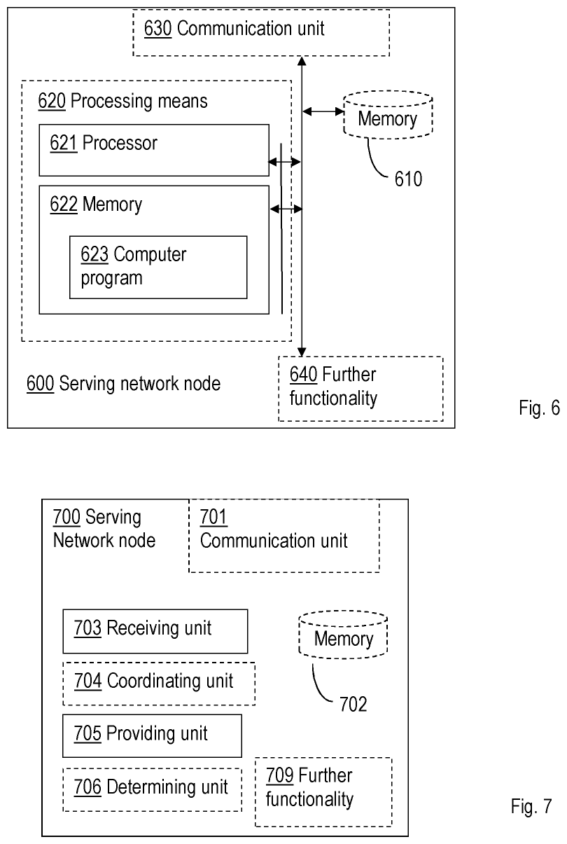

Embodiments herein also relate to a serving network node operable in a wireless communication network supporting beamforming for communication between a wireless device and the serving network node. Exemplifying embodiments of such a serving network node will now be described with reference to FIGS. 6 and 7.

FIGS. 6 and 7 illustrate the serving network node 600, 700 being configured for receiving a measurement report, from the wireless device, the measurement report indicating one or more interference measurements at respective one or more time instances; and providing, to the wireless device, a CSI measurement assignment associated with the one or more interference measurements. The serving network node 600, 700 is also configured for receiving an interference matching pre-coder matching the associated one or more interference measurements.

The serving network node 400, 500 may be implemented or realised in different ways. An exemplifying implementation is illustrated in FIG. 6. FIG. 6 illustrates the serving network node 600 comprising a processor 621 and memory 622, the memory comprising instructions, e.g. by means of a computer program 623, which when executed by the processor 621 causes the serving network node 600 to receive a measurement report, from the wireless device, the measurement report indicating one or more interference measurements at respective one or more time instances; to provide, to the wireless device, a CSI measurement assignment associated with the one or more interference measurements; and to receive an interference matching pre-coder matching the associated one or more interference measurements.

FIG. 6 also illustrates the serving network node 600 comprising a memory 610. It shall be pointed out that FIG. 6 is merely an exemplifying illustration and memory 610 may optionally, be a part of the memory 622 or be a further memory of the serving network node 600. The memory may for example comprise information relating to the serving network node 600, to statistics of operation of the serving network node 600, just to give a couple of illustrating examples. FIG. 6 further illustrates the serving network node 600 comprising processing means 620, which comprises the memory 622 and the processor 621. Still further, FIG. 6 illustrates the serving network node 600 comprising a communication unit 630. The communication unit 630 may comprise an interface through which the serving network node 600 communicates with other nodes, servers, wireless devices or entities of the communication network. FIG. 6 also illustrates the serving network node 600 comprising further functionality 640. The further functionality 640 may comprise hardware of software necessary for the serving network node 600 to perform different tasks that are not disclosed herein.

An alternative exemplifying implementation of the serving network node 600, 700 is illustrated in FIG. 7. FIG. 7 illustrates the serving network node 700 comprising a receiving unit 703 for receiving a measurement report, from the wireless device, the measurement report indicating one or more interference measurements at respective one or more time instances. FIG. 7 also illustrates the serving network node 700 comprising a providing unit 704 for providing, to the wireless device, a CSI measurement assignment associated with the one or more interference measurements. By means of the receiving unit 703, the serving network node 700 is also configured for receiving an interference matching pre-coder matching the associated one or more interference measurements.

In FIG. 7, the serving network node 700 is also illustrated comprising a communication unit 701. Through this unit, the serving network node 700 is adapted to communicate with other nodes and/or entities in the communication network. The communication unit 701 may comprise more than one receiving arrangement. For example, the communication unit may be connected to both a wire and an antenna, by means of which the serving network node 700 is enabled to communicate with other nodes and/or entities in the communication network. Similarly, the communication unit 701 may comprise more than one transmitting arrangement, which in turn is connected to both a wire and an antenna, by means of which the serving network node 700 s enabled to communicate with other nodes and/or entities in the communication network. The serving network node 700 further comprises a memory 702 for storing data. Further, the serving network node 700 may comprise a control or processing unit (not shown) which in turn is connected to the different units 703-704. It shall be pointed out that this is merely an illustrative example and the serving network node 700 may comprise more, less or other units or modules which execute the functions of the serving network node 700 in the same manner as the units illustrated in FIG. 7.

It should be noted that FIG. 7 merely illustrates various functional units in the serving network node 700 in a logical sense. The functions in practice may be implemented using any suitable software and hardware means/circuits etc. Thus, the embodiments are generally not limited to the shown structures of the serving network node 700 and the functional units. Hence, the previously described exemplary embodiments may be realised in many ways. For example, one embodiment includes a computer-readable medium having instructions stored thereon that are executable by the control or processing unit for executing the method steps in the serving network node 700. The instructions executable by the computing system and stored on the computer-readable medium perform the method steps of the serving network node 700 as described in the different embodiments herein.

The serving network node has the same possible advantages as the method performed by the serving network node. One possible advantage is that the interference source in a Multiple User, MU,-MIMO scenario with large antenna arrays may be efficiently identified. The solution may both lower overhead in measurement scenarios that could have been handled by legacy solutions and it may enables measurements when legacy methods would not work. Further the measurement reports may be made smaller by only reporting relevant information in relation to the interference. For large antenna arrays the cost of measuring the complete channel (as is done in state of the art solutions) is too high i.e. too many CSI-RS resources are needed or it is needed to use Sounding Reference Signal, SRS, for the reciprocity case which causes high SRS interference in the serving node. In such scenarios, the proposed solution herein the measurement reports may be made smaller by only reporting relevant information in relation to the interference. Even if the CSI measurement are performed according to the state of the art solutions, there may be multiple beam-forming vectors that are not causing interference that may trigger wrong and/or high overhead reporting and that these beam-forming vectors could hinder identification. In some more rare scenarios these strong beam-forming vectors could also block measuring relevant weaker vectors, either or both due to receiver impairments and the power control on SRS.

One or more measurement report may indicate that a non-typical level of interference was detected by the wireless device.

The serving network node 600, 700 may further be configured for coordinating transmission of Channel State Information Reference Signal(s), CSI-RS, with one of more neighbouring network nodes.

The CSI measurement assignment may be associated with the one or more interference measurements indicating the non-typical level of interference.

The non-typical level of interference may correspond to the level of interference not meeting a predetermined threshold.

The coordinating of transmission of CSI-RS, with one of more neighbouring network nodes may comprise the serving network node 600, 700 being configured for determining which pre-coders where used in the transmission(s) at the respective time instance(s) that caused the non-typical level of interference was at the wireless device.

The serving network node 600, 700 may further be configured for receiving measurement report(s) from one or more other wireless devices, the individual measurement report(s) being associated with measured received signal strength(s) of CSI-RS transmitted by the serving network node, and selecting a set of pre-coders based on the received measurement reports, wherein the number of pre-coders in the set are smaller than the total number of pre-coders associated with the received measurement reports.

The selecting of the set of pre-coders may comprise the serving network node 600, 700 being configured for removing the pre-coders associated with the weakest eigenvalues in a Singular Value Decomposition, SVD, for the wireless devices.

The serving network node 600, 700 may still further be configured for agreeing with respective one or more neighbouring network nodes that the respective one or more neighbouring network nodes will not schedule transmissions to its/their wireless device(s) using pre-coders causing the non-typical level of interference simultaneously to the serving network node scheduling transmission to the wireless device.

The serving network node 600, 700 may yet further being configured for agreeing with respective one or more neighbouring network nodes to not schedule transmissions to the wireless device using pre-coders causing the non-typical level of interference simultaneously to the one or more network nodes scheduling transmission(s) to its/their wireless device(s) using those pre-coders.

The serving network node 600, 700 may further being configured for transmitting a request to the wireless device for the transmission of the interference matching pre-coder.

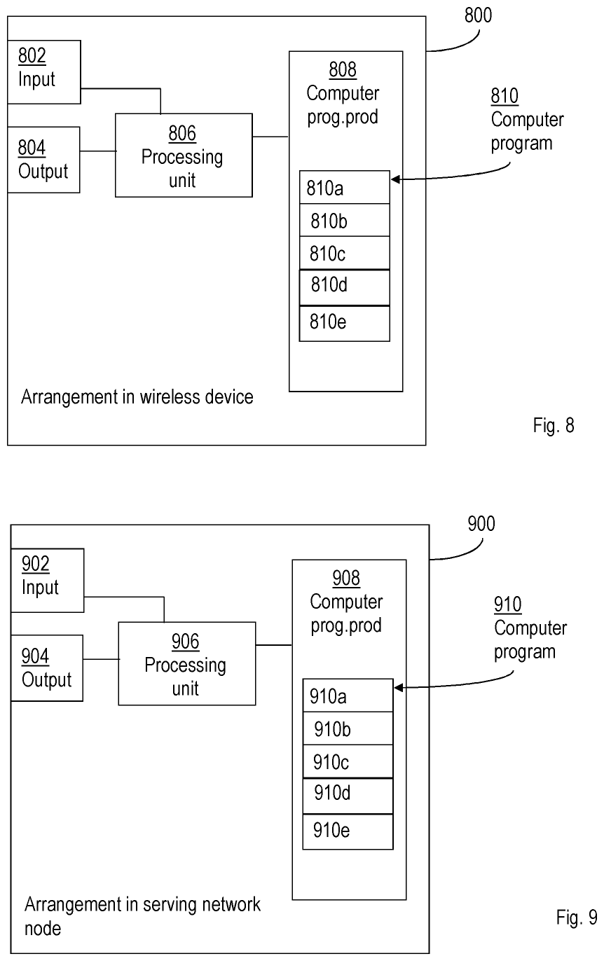

FIG. 8 schematically shows an embodiment of an arrangement 800 in a wireless device 500. Comprised in the arrangement 800 in the wireless device 500 are here a processing unit 806, e.g. with a Digital Signal Processor, DSP. The processing unit 806 may be a single unit or a plurality of units to perform different actions of procedures described herein. The arrangement 800 of the wireless device 500 may also comprise an input unit 802 for receiving signals from other entities, and an output unit 804 for providing signal(s) to other entities. The input unit and the output unit may be arranged as an integrated entity or as illustrated in the example of FIG. 5, as one or more interfaces 501.

Furthermore, the arrangement 800 in the wireless device 500 comprises at least one computer program product 808 in the form of a non-volatile memory, e.g. an Electrically Erasable Programmable Read-Only Memory, EEPROM, a flash memory and a hard drive. The computer program product 808 comprises a computer program 810, which comprises code means, which when executed in the processing unit 806 in the arrangement 800 in the wireless device 500 causes the wireless device 500 to perform the actions e.g. of the procedure described earlier in conjunction with any of FIGS. 1a-1d.

The computer program 810 may be configured as a computer program code structured in computer program modules 810a-810e. Hence, in an exemplifying embodiment, the code means in the computer program of the arrangement 800 in the wireless device 500 comprises an obtaining unit, or module, for obtaining one or more interference measurements at respective one or more time instances; and a receiving unit, or module, for receiving, from the serving network node, a Channel State Information, CSI, measurement assignment associated with the one or more interference measurements. The obtaining unit, or module, is also used for obtaining a channel estimation based on a CSI-RS transmission. The code means in the computer program of the arrangement 800 in the wireless device 500 further comprises a determining unit, or module, for determining a pre-coder based on the obtained channel estimation matching estimated interference according to one or more interference measurements; and an informing unit, or module, for informing the serving network node about the determined interference matching pre-coder.

The computer program modules could essentially perform the actions of the flow illustrated in any of FIGS. 1a-1d, to emulate the wireless device 500. In other words, when the different computer program modules are executed in the processing unit 806, they may correspond to the units 503-506 of FIG. 5.

FIG. 9 schematically shows an embodiment of an arrangement 900 in a serving network node 700. Comprised in the arrangement 900 in the serving network node 700 are here a processing unit 906, e.g. with DSP. The processing unit 906 may be a single unit or a plurality of units to perform different actions of procedures described herein. The arrangement 900 of the serving network node 700 may also comprise an input unit 902 for receiving signals from other entities, and an output unit 904 for providing signal(s) to other entities. The input unit and the output unit may be arranged as an integrated entity or as illustrated in the example of FIG. 7, as one or more interfaces 701.

Furthermore, the arrangement 900 in the serving network node 700 comprises at least one computer program product 908 in the form of a non-volatile memory, e.g. an EEPROM, a flash memory and a hard drive. The computer program product 908 comprises a computer program 910, which comprises code means, which when executed in the processing unit 906 in the arrangement 900 in the serving network node 700 causes the serving network node 700 to perform the actions e.g. of the procedure described earlier in conjunction with any of FIGS. 2a-2d.

The computer program 910 may be configured as a computer program code structured in computer program modules 910a-910e. Hence, in an exemplifying embodiment, the code means in the computer program of the arrangement 900 in the serving network node 700 comprises a receiving unit, or module, for receiving a measurement report, from the wireless device, the measurement report indicating one or more interference measurements at respective one or more time instances; and a providing unit, or module, for providing, to the wireless device, a CSI measurement assignment associated with the one or more interference measurements. The receiving unit, or module, is also used for receiving an interference matching pre-coder matching the associated one or more interference measurements.

The computer program modules could essentially perform the actions of the flow illustrated in any of FIGS. 2a-2d 4, to emulate the serving network node 700. In other words, when the different computer program modules are executed in the processing unit 906, they may correspond to the units 703-704 of FIG. 7.

Although the code means in the embodiments disclosed above in conjunction with FIGS. 5 and 7 are implemented as computer program modules which when executed in the respective processing unit causes the serving network node and the wireless device to perform the actions described above in the conjunction with figures mentioned above, at least one of the code means may in alternative embodiments be implemented at least partly as hardware circuits.

The processor may be a single Central Processing Unit, CPU, but could also comprise two or more processing units. For example, the processor may include general purpose microprocessors; instruction set processors and/or related chips sets and/or special purpose microprocessors such as Application Specific Integrated Circuits, ASICs. The processor may also comprise board memory for caching purposes. The computer program may be carried by a computer program product connected to the processor. The computer program product may comprise a computer readable medium on which the computer program is stored. For example, the computer program product may be a flash memory, a Random-Access Memory RAM, Read-Only Memory, ROM, or an EEPROM, and the computer program modules described above could in alternative embodiments be distributed on different computer program products in the form of memories within the serving network node and the wireless device respectively.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended embodiments include such alternatives, modifications, permutations and equivalents as fall within the scope of the embodiments and defined by the appended embodiments.

1-52. (canceled)

53. A method performed by a wireless device for transmission of an interference matching pre-coder, the wireless device being operable in a wireless communication network supporting beamforming for communication between the wireless device and a serving network node, the method comprising:
obtaining one or more interference measurements at respective one or more time instances;
receiving, from the serving network node, a Channel State Information (CSI) measurement assignment associated with the one or more interference measurements;
obtaining a channel estimation based on a CSI Reference Signal (CSI-RS) transmission;
determining, based on the channel estimation, a pre-coder matching estimated interference according to the one or more interference measurements; and
transmitting, to the serving network node, the interference matching pre-coder.

54. The method according to claim 53, further comprising providing an interference measurement report to the serving network node when one or more of the one or more interference measurements indicates a non-typical level of interference.

55. The method according to claim 54, wherein the received CSI measurement assignment is associated with the one or more interference measurements indicating the non-typical level of interference.

56. The method according to claim 53, wherein the transmitting of the interference matching pre-coder comprises transmitting an associated quality value and the channel estimation.

57. The method according to claim 56, wherein the channel estimation is represented by a Channel Quality Indicator (CQI) value.

58. The method according to claim 53, further comprising receiving a request from the serving network node for the transmission of the interference matching pre-coder.

59. The method according to claim 53, wherein obtaining the one or more interference measurements at respective one or more time instances comprises receiving respective transmissions from neighboring network nodes and/or wireless devices, and determining interference measurements based on the received transmissions and determining covariance matrices based on the interference measurements.

60. The method according to claim 53, wherein obtaining the one or more interference measurements comprises performing measurements on one or more CSI interference measurement resources.

61. The method according to claim 53, wherein obtaining the one or more interference measurements comprises performing measurements on at least one of (a) one or more CSI reference signal measurement resources, and estimating interference based on a channel estimate of a CSI-RS, and (b) one or more Demodulation Reference Signals (DMRS) measurement resources, and estimating interference based on a channel estimate of a DMRS.

62. A method performed by a serving network node operable in a wireless communication network supporting beamforming for communication between a wireless device and the serving network node, the method comprising:
receiving a measurement report, from the wireless device, the measurement report indicating one or more interference measurements at respective one or more time instances;
providing, to the wireless device, a Channel State Information (CSI) measurement assignment associated with the one or more interference measurements; and
receiving, from the wireless device, an interference matching pre-coder matching the one or more interference measurements.

63. The method according to claim 62, wherein the measurement report indicates that a non-typical level of interference was detected by the wireless device.

64. The method according to claim 62, further comprising coordinating transmission of CSI Reference Signals (CSI-RS) with one or more neighboring network nodes.

65. The method according to claim 63, wherein the CSI measurement assignment is associated with the one or more interference measurements indicating the non-typical level of interference.

66. The method according to claim 63, wherein the non-typical level of interference corresponds to the level of interference not meeting a predetermined threshold.

67. The method according to claim 64, wherein the coordinating of transmission of CSI-RS, with one or more neighboring network nodes comprises determining which pre-coders where used in the transmissions at the respective time instances that caused the non-typical level of interference at the wireless device.

68. The method according to claim 62, further comprising receiving measurement reports from one or more other wireless devices, the individual measurement reports being associated with measured received signal strengths of CSI-RS transmitted by the serving network node, and selecting a set of pre-coders based on the received measurement reports, wherein the number of pre-coders in the set are smaller than the total number of pre-coders associated with the received measurement reports.

69. The method according to claim 66, wherein selecting the set of pre-coders comprises removing the pre-coders associated with the weakest eigenvalues in a Singular Value Decomposition (SVD) for the wireless devices.

70. The method according to claim 62, further comprising agreeing with respective one or more neighboring network nodes that the respective one or more neighboring network nodes will not schedule transmissions to their wireless devices using pre-coders, causing the non-typical level of interference, simultaneously to the serving network node scheduling transmission to the wireless device.

71. A wireless device configured for transmission of an interference matching pre-coder, the wireless device being operable in a wireless communication network supporting beamforming for communication between the wireless device and a serving network node, the wireless device comprising:
a processor; and
a memory, the memory comprising instructions executable by the processor whereby the wireless device is operative to:
obtain one or more interference measurements at respective one or more time instances;
receive, from the serving network node, a Channel State Information (CSI) measurement assignment associated with the one or more interference measurements;
obtain a channel estimation based on a CSI Reference Signal (CSI-RS) transmission;
determine, based on the channel estimation, a pre-coder matching estimated interference according to the one or more interference measurements; and
transmit, to the serving network node, the interference matching pre-coder.

72. A serving network node configured to be operable in a wireless communication network supporting beamforming for communication between a wireless device and the serving network node, the serving network node comprising:
a processor; and
a memory, the memory comprising instructions executable by the processor whereby the serving network node is operative to:
receive a measurement report, from the wireless device, the measurement report indicating one or more interference measurements at respective one or more time instances;
provide, to the wireless device, a Channel State Information (CSI) measurement assignment associated with the one or more interference measurements; and
receive, from the wireless device, an interference matching pre-coder matching the one or more interference measurements.
